(19) United States
(12) Patent Application Publication
(10) Pub. No.: US 2021/0356801 A1
(43) Pub. Date: Nov. 18, 2021

(54) DISPLAY PANEL AND DISPLAY DEVICE

(71) Applicant: Shenzhen China Star Optoelectronics Semiconductor Display Technology Co., Ltd., Shenzhen, Guangdong (CN)

(72) Inventors: Xuedong MEI, Shenzhen, Guangdong (CN); Bangyin PENG, Shenzhen, Guangdong (CN); Ilgon KIM, Shenzhen, Guangdong (CN)

(73) Assignee: Shenzhen China Star Optoelectronics Semiconductor Display Technology Co., Ltd., Shenzhen, Guangdong (CN)

(21) Appl. No.: 16/964,218

(22) PCT Filed: Apr. 29, 2020
(86) PCT No.: PCT/CN2020/087719

§ 371 Date: Jul. 23, 2020

(30) Foreign Application Priority Data
Apr. 8, 2020 (CN) 202010277760.2

(51) Int. Cl. G02F 1/1333; G02F 1/1343

(52) U.S. Cl. CPC G02F 1/133371; G02F 1/13685; G02F 1/134345; G02F 1/133345

(57) ABSTRACT

A display panel and a display device are provided. The display panel is provided with a first substrate, a second substrate, and a liquid crystal layer between the first substrate and the second substrate. The first substrate has a base, an array an array structure layer, and a pixel electrode layer. The pixel electrode layer has at least one pixel electrode, and each of the pixel electrode comprises a first region and a second region adjacent to the first region. A thickness of the liquid crystal layer corresponding to the first region is greater than a thickness of the liquid crystal layer corresponding to the second region.

### FIELD OF INVENTION

The present disclosure relates to a display technical field, and specifically, to a display panel and a display device.

### BACKGROUND OF INVENTION

Liquid crystal displays (LCDs) are widely used flat panel displays, which realizes image display by modulating the light field intensity of a backlight source through liquid crystals. However, since the liquid crystals show the optical anisotropy, when users watch a display screen at different angles, the brightness watched by the users are different at different angles. This causes the LCD display screen has a narrower viewing angle. In the prior art, the pixel electrode is designed into a multi-domain structure, such as an eight-domain pixel electrode, and the brightness of a sub-pixel region is divided into two different portions. The brightness at different viewing angles are used to complement each other to achieve a large viewing angle.

### SUMMARY OF DISCLOSURE

### Technical Problem

With the development of the display technology, in high-resolution display panels, such as 8K liquid crystal displays, pixels are getting denser, and the pixel area is getting smaller. Due to space limitations, the four-domain pixel electrode structure is generally used, and the problem of narrow viewing angles in the high-resolution display panel cannot be solved well, so that the image quality of the display panel is seriously affected.

### Technical Solutions

The present disclosure provides a display panel and a display device to solve the problems that current display panels are limited to small pixel sizes so that the multi-domain partitioned pixel structure would not be applicable to expand the viewing angle of the display panel.

To solve above problems, the present disclosure provides technical solutions as follows:

The present disclosure provides a display panel, comprising a first substrate, a second substrate opposite to the first substrate, and a liquid crystal layer between the first substrate and the second substrate;

wherein the first substrate comprises a base, an array structure layer on the base, and a pixel electrode layer on the array structure layer; and

the pixel electrode layer comprises at least one pixel electrode, and each of the pixel electrode comprises a first region and a second region adjacent to the first region, wherein a thickness of the liquid crystal layer corresponding to the first region is greater than a thickness of the liquid crystal layer corresponding to the second region.

In the display panel of the present disclosure, a thickness of the array structure layer corresponding to the first region is less than a thickness of the array structure layer corresponding to the second region so that the thickness of the liquid crystal layer corresponding to the first region is greater than the thickness of the liquid crystal layer corresponding to the second region.

In the display panel of the present disclosure, the array structure layer comprises a thin film transistor layer disposed on the base and a first insulating layer disposed on the thin film transistor layer, wherein a thickness of the first insulating layer corresponding to the first region is less than the thickness of the first insulating layer corresponding to the second region.

In the display panel of the present disclosure, the display panel further comprises a color resist layer disposed between the array structure layer and the pixel electrode; the display panel at least comprises a first color sub-pixel area configured to display a first color and a second color sub-pixel area configured to display a second color; the first color sub-pixel area and the second color sub-pixel area are correspondingly provided with one of the pixel electrodes, respectively; the first color has a wavelength greater than a wavelength of the second color;

a refractive index of the first insulating layer corresponding to the first color sub-pixel area is greater than a refractive index of the first insulating layer corresponding to the second color sub-pixel area; and/or

an average liquid crystal thickness of the liquid crystal layer corresponding to the first color sub-pixel area is greater than an average liquid crystal thickness of the liquid crystal layer corresponding to the second color sub-pixel area.

In the display panel of the present disclosure, the first insulating layer comprises a first layer corresponding to the first color sub-pixel area and a second layer corresponding to the second color sub-pixel area, and a refractive index of a material of the first layer is greater than a refractive index of a material of the second layer.

In the display panel of the present disclosure, a thickness of the array structure layer corresponding to the first color sub-pixel area is less than a thickness of the array structure layer corresponding to the second color sub-pixel area, so that the average liquid crystal thickness of the liquid crystal layer corresponding to the first color sub-pixel area is greater than the average liquid crystal thickness of the liquid crystal layer corresponding to the second color sub-pixel area.

In the display panel of the present disclosure, a thickness of the first insulating layer corresponding to the first color sub-pixel area is less than a thickness of the first insulating layer corresponding to the second color sub-pixel area.

In the display panel of the present disclosure, the second region comprises two second sub-regions, the first region corresponds to the central portion of the pixel electrode, the two second sub-regions correspond to two end portions of the pixel electrode, respectively, and are adjacent to two sides of the first region.

In the display panel of the present disclosure, an area of the first region is equal to an area of the second region.

The present disclosure further provides a display device comprising a backlight module, and a display panel on the backlight module;

wherein the display panel comprises a first substrate, a second substrate opposite to the first substrate, and a liquid crystal layer between the first substrate and the second substrate;

wherein the first substrate comprises a base, an array structure layer on the base, and a pixel electrode layer on the array structure layer; and

the pixel electrode layer comprises at least one pixel electrode, and each of the pixel electrode comprises a first region and a second region adjacent to the first region, wherein a thickness of the liquid crystal layer corresponding to the first region is greater than a thickness of the liquid crystal layer corresponding to the second region.

In the display device of the present disclosure, a thickness of the array structure layer corresponding to the first region is less than a thickness of the array structure layer corresponding to the second region so that the thickness of the liquid crystal layer corresponding to the first region is greater than the thickness of the liquid crystal layer corresponding to the second region.

In the display device of the present disclosure, the array structure layer comprises a thin film transistor layer disposed on the base and a first insulating layer disposed on the thin film transistor layer, wherein a thickness of the first insulating layer corresponding to the first region is less than the thickness of the first insulating layer corresponding to the second region.

In the display device of the present disclosure, the display device further comprises a color resist layer disposed between the array structure layer and the pixel electrode; the display panel at least comprises a first color sub-pixel area configured to display a first color and a second color sub-pixel area configured to display a second color; the first color sub-pixel area and the second color sub-pixel area are correspondingly provided with one of the pixel electrodes, respectively; the first color has a wavelength greater than a wavelength of the second color;

a refractive index of the first insulating layer corresponding to the first color sub-pixel area is greater than a refractive index of the first insulating layer corresponding to the second color sub-pixel area; and/or

an average liquid crystal thickness of the liquid crystal layer corresponding to the first color sub-pixel area is greater than an average liquid crystal thickness of the liquid crystal layer corresponding to the second color sub-pixel area.

In the display device of the present disclosure, the first insulating layer comprises a first layer corresponding to the first color sub-pixel area and a second layer corresponding to the second color sub-pixel area, a refractive index of a material of the first layer is greater than a refractive index of a material of the second layer.

In the display device of the present disclosure, a thickness of the array structure layer corresponding to the first color sub-pixel area is less than a thickness of the array structure layer corresponding to the second color sub-pixel area, so that the average liquid crystal thickness of the liquid crystal layer corresponding to the first color sub-pixel area is greater than the average liquid crystal thickness of the liquid crystal layer corresponding to the second color sub-pixel area.

In the display device of the present disclosure, a thickness of the first insulating layer corresponding to the first color sub-pixel area is less than a thickness of the first insulating layer corresponding to the second color sub-pixel area.

In the display device of the present disclosure, the second region comprises two second sub-regions, the first region corresponds to the central portion of the pixel electrode; the two second sub-regions correspond to two end portions of the pixel electrode, respectively, and are adjacent to two sides of the first region.

In the display device of the present disclosure, an area of the first region is equal to an area of the second region.

### Beneficial Effect

The beneficial effect of the present disclosure is that the pixel electrode in the present disclosure is divided into a first region and a second region adjacent to the first region, and a thickness of the liquid crystal layer corresponding to the first region is greater than a thickness of the liquid crystal layer corresponding to the second region, so that the light emitted from the liquid crystal layer with different thicknesses shows different brightness to realize the brightness complement of the pixel electrode corresponding to the first region and the second region, thereby solving the problem of differences of viewing angles under different viewing angles of the display panel with high resolution.

### BRIEF DESCRIPTION OF DRAWINGS

In order to more clearly illustrate the technical solutions in the embodiment or in the present disclosure, the following drawings, which are intended to be used in the description of the embodiment or of the present disclosure, will be briefly described. It is understood that the drawings described below are merely some embodiments of the present disclosure, and it will be possible to those skilled in the art to obtain other drawings according to these drawings without creative efforts.

FIG. 1 is a first top view showing a display panel of the present disclosure.

FIG. 2 is a second top view showing a display panel of the present disclosure.

FIG. 3 is a schematic view showing a cross-section along A-A in FIG. 2.

FIG. 4 is a third top view showing a display panel of the present disclosure.

FIG. 5 is a schematic view showing a cross-section along B-B in FIG. 4.

FIG. 6 is another schematic view showing a cross-section along B-B in FIG. 4.

FIG. 7 is a schematic view showing a display device of the present disclosure.

### DETAILED DESCRIPTION OF PREFERRED EMBODIMENTS

The description of the following embodiments is used for exemplifying the specific embodiments of the present invention by referring to the accompany drawings. Furthermore, directional terms described by the present invention, such as upper, lower, front, back, left, right, inner, outer, side, etc., are only directions by referring to the accompanying drawings, and thus the directional terms are used to describe and understand the present invention, but the present invention is not limited thereto. In the drawings, like reference numerals designate like elements throughout the specification.

In the description of the present disclosure, it should be understood that the terms “center”, “longitudinal”, “lateral”, “length”, “width”, “thickness”, “upper”, “lower”, “front”, “back”, “left”, “right”, “vertical ”, “horizontal”, “top”, “bottom”, “inner”, “outer”, “clockwise”, “counterclockwise”, etc., for indicating orientation or position are based on the orientation or position shown in the drawings, which are merely for the convenience of describing the present disclosure and simplifying the description, rather than for indicating or implying that the devices or elements referred to must have a specific orientation or should be constructed and operated with specific position, and thus cannot be understood as a limitation of the present disclosure. Moreover, the terms “first” and “second” are used for description only, and cannot be understood as indicating or implying relative importance, or the number of technical features indicated. Thus, features defined as “first” and “second” may explicitly or implicitly include one or more of the features. In the description of the present disclosure, “multiple” means two or more than two, unless it is specifically defined.

In the description of the present disclosure, it should be noted that, unless clearly specified and limited, the terms “installation”, “connection”, and “association” should be understood in a broad meaning. For example, it can refer to a fixed connection, a disassembly connection, or an integral connection. It can also refer to a mechanical connection, an electrical connection, or a communication with each other. It can refer to a direct connection, an indirect connection through an intermediary, an internal communication between two components or an interaction between two components. For those of ordinary skill in the art, the specific meaning of the above terms in the present disclosure can be understood according to specific circumstances.

In the present disclosure, unless explicitly stated and limited, the description of the first feature “above” or “below” the second feature may include direct contact between the first feature and second features, or may include indirect contact through another feature between the first feature and second features. Moreover, the first feature “above”, “on” and “over” the second feature means that the first feature is directly above and obliquely above the second feature, or simply means that the first feature is located at a position higher than a position where the second feature is located at. The first feature “below”, “under” and “beneath” the second feature means that the first feature is directly below and obliquely below the second feature, or simply means that the first feature is located at a position lower than a position where the second feature is located at.

The following disclosure provides many different embodiments or examples for implementing different structures of the present disclosure. For simplify the present disclosure, the components and configuration of the specific embodiment are described below. Of course, they are only examples, and the purpose is not to limit the present disclosure. Moreover, the present disclosure may repeat reference numbers and/or reference letters in different examples. This repetition is for simplicity and clarity, and does not in itself indicate the relationship between the various embodiments and/or configurations discussed. Additionally, the present disclosure provides examples of various specific processes and materials, but those of ordinary skill in the art may be aware of the applications of other processes and/or the uses of other materials.

The technical solutions of the present disclosure will be described now with references to specific embodiments.

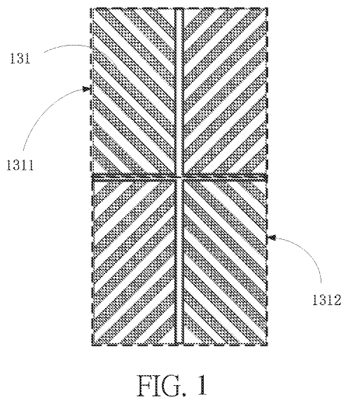

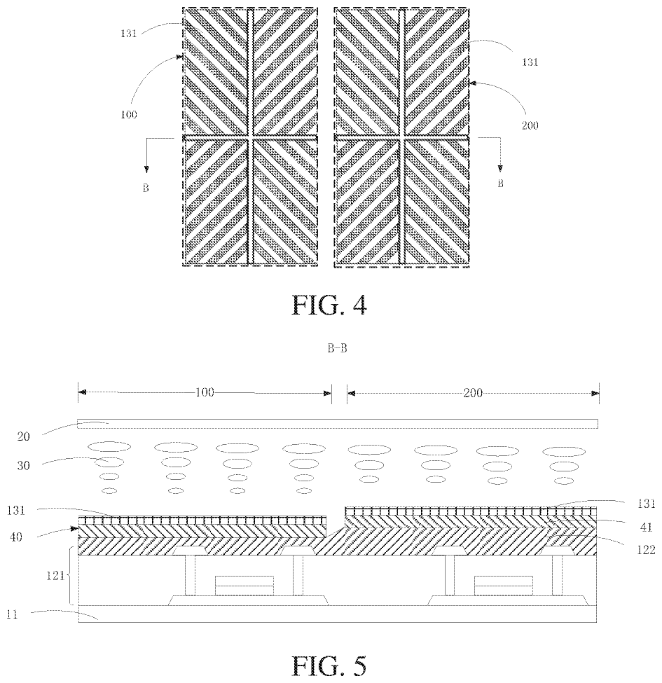

The present disclosure provides a display panel 1, as shown in FIGS. 1 to 6, comprising a first substrate 10, a second substrate 20 opposite to the first substrate 10, and a liquid crystal layer 30 between the first substrate 10 and the second substrate 20.

the first substrate 10 comprises a base 11, an array structure layer 12 on the base 11, and a pixel electrode layer 13 on the array structure layer 12.

The pixel electrode layer 13 comprises at least one pixel electrode 131, and each of the pixel electrode 131 comprises a first region 1311 and a second region 1312 adjacent to the first region 1311. A thickness of the liquid crystal layer 30 corresponding to the first region 1311 is greater than a thickness of the liquid crystal layer 30 corresponding to the second region 1312.

It can be understood that pixels are dense and the pixel area is small in conventional high-resolution display panels of 8K liquid crystal displays, so the multi-domain structure, such as an eight-domain pixel electrode cannot be used to divide the brightness of a sub-pixel area of the pixel electrode into two different parts, so as to achieve a large viewing angle through the complementary brightness of different viewing angles. Only the pixel structure with high transmittance, such as a four-domain pixel electrode, can be used, which cannot solve the problem of narrow viewing angles of high-resolution display panels, and the image quality of the display panel is seriously affected. The pixel electrode 131 in the present disclosure is divided into a first region 1311 and a second region 1312 adjacent to the first region 1311, and a thickness of the liquid crystal layer 30 corresponding to the first region 1311 is greater than a thickness of the liquid crystal layer 30 corresponding to the second region 1312, so that the light emitted from the liquid crystal layer 30 with different thicknesses shows different brightness to realize the brightness complement of the pixel electrode 131 corresponding to the first region 1311 and the second region 1312, thereby solving the problem of differences of viewing angles under different viewing angles of the display panel with high resolution. It is characterized that the pixel electrode 131 can be a four-domain pixel electrode, and other low-domain pixel electrodes. In the present disclosure, the pixel electrode 131 is, for example, a four-domain pixel electrode. Unless otherwise specified, each pixel electrode 131 is a four-domain pixel electrode. Apparently, in the present disclosure, the pixel electrode 131 is partitioned and corresponds to different thicknesses of the liquid crystal layer to achieve brightness complement of different regions, so as to solve the problem of narrow viewing angles in the display panel with high resolution. Moreover, the four-domain pixel electrode has a higher transmittance than the eight-domain pixel electrode, and this is also beneficial to improve the overall transmittance of the display panel.

As mentioned above, as shown in FIG. 3. Apparently, the first substrate 10 may have various structures, and is not limited thereto. The base 11 may be one of rigid base or flexible base. When the base 11 is rigid, the material of the base may be glass, or quartz. When the base 11 is flexible, the base 11 may be made of polyimide. In the LCD display panel, the base 11 is generally a rigid base, which is not described in detail here.

It is noted that a thickness of the liquid crystal layer 30 corresponding to the first region 1311 is greater than a thickness of the liquid crystal layer 30 corresponding to the second region 1312. That is, a distance between the first substrate 10 and the second substrate 20 corresponding to the first region 1311 is greater than a distance between the first substrate 10 and the second substrate 20 corresponding to the second region 1312, so that the liquid crystal layer 30 filled between the first substrate 10 and the second substrate 20 has different thicknesses corresponding to different regions. In one embodiment, the thickness of different layers in the display panel 1 can be modified to achieve the different thickness of the liquid crystal layer corresponding to the first region 1311 and the second region 1312. Specifically, a layer of the display panel 1 can be adjusted and thicknesses of other layers are controlled. It is also possible to comprehensively adjust the thicknesses of the multiple layers in the display panel 1 to achieve the adjustment of the spacing between the first substrate 10 and the second substrate 20, so as to achieve different thicknesses of the liquid crystal layer corresponding to first region 1311 and the second region 1312. The specific adjustment method and the specific film structure to be adjusted are not limited here.

As mentioned above, in specific use, the backlight passes through different thicknesses of the liquid crystal layer corresponding to the first region 1311 and the second region 1312 to emit light in different brightness, so as to achieve brightness complement of the first region 1311 and the second region 1312 under different viewing angles. The problem of differences of viewing angles existing in the four-domain pixel electrode is solved well. Additionally, since the thickness of the liquid crystal layer 30 corresponding to the first region 1311 is greater than the thickness of the liquid crystal layer 30 corresponding to the second region 1312, the brightness of the first region 1311 is greater than the brightness of the second region 1312, so that the display effect of the eight-domain pixel electrode can be achieved by a four-domain pixel electrode 131. In this embodiment, under specific conditions, by adjusting the difference between the thickness of the liquid crystal layer 30 corresponding to the first region 1311 and the thickness of the liquid crystal layer 30 corresponding to the second region 1312, the sum of the brightness value within the first region 1311 and the brightness value of the second region 1312 is always kept a constant value under different viewing angles. For example, in a first viewing angle, the brightness value of the first region 1311 is L11, and the brightness value of the second region 1312 is L12; in a second viewing angle, the brightness value of the first region 1311 is L21, and the brightness value of the second region 1312 is L22, wherein L11<L12 and L21<L22; and L11+L12=L21+L22; thereby solving the problem of the difference of the viewing angles in the display panel 1 under different viewing angles.

In one embodiment, as shown in FIG. 3, a thickness of the array structure layer 12 corresponding to the first region 1311 is less than a thickness of the array structure layer 12 corresponding to the second region 1312, so that the thickness of the liquid crystal layer 30 corresponding to the first region 1311 is greater than the thickness of the liquid crystal layer 30 corresponding to the second region 1312. Apparently, in this embodiment, it is possible to keep the thicknesses of the second substrate 20, the base 11, and the pixel electrode layer 13 unchanged and adjust the thickness of the array structure layer 12 corresponding to the first region 1311 and the second region 1312 to achieve the adjustment of the spacing between the first substrate 10 and the second substrate 20 corresponding to the first region 1311 and the second region 1312, so that the liquid crystal layer 30 filled between the first substrate 10 and the second substrate 20 has different thicknesses of the liquid crystal layer corresponding to first region 1311 and the second region 1312.

As mentioned above, as shown in FIG. 3, specifically, the array structure layer 12 includes a thin film transistor layer 121 disposed on the base 11 and a first insulating layer 122 disposed on the thin film transistor layer 121, wherein a thickness of the first insulating layer 122 corresponding to the first region 1311 is less than the thickness of the first insulating layer 122 corresponding to the second region 1312. It is characterized that materials of the first insulating layer 122 may be various. In this embodiment, the first insulating layer 122 is specifically a polymer film on array (PFA) structure. The material of the first insulating layer 122 is an organic material. In this embodiment, the thickness of the thin film transistor layer 121 is kept constant by specifically adjusting the thicknesses of the first insulating layer 122 corresponding to the first region 1311 and the second region 1312 to achieve the adjustment of the thickness of the array structure layer 12 corresponding to the first region 1311 and the second region 1312. Apparently, the first insulating layer 122 is located at one side of the array structure layer 12 close to the liquid crystal layer 30, and it is possible to adjust the thickness of the first insulating layer 122 to minimize the influence on the thin film transistor layer 121 in the array structure layer 12. It can be understood that the pixel electrode layer 13 is disposed between the first insulating layer 122 and the liquid crystal layer 30, and because the thickness of the first insulating layer 122 corresponding to the first region 1311 is less than the thickness of the first insulating layer corresponding to the second region 1312, the first insulating layer 122 forms a concave at the first region 1311. The pixel electrode layer 13 corresponding to the first region 1311 fits the first insulating layer 122 and forms a concave. In this embodiment, the display panel 1 further comprises a color resist layer 40 which is either disposed on one side of the first substrate 10 or one side of the second substrate 20, it is not limited thereto. For preventing the color resist layer 40 or other functional layers in the display panel 1 from the influence resulting from different thicknesses of the first insulating layer 122 corresponding to the first region 1311 and the second region 1312, it is possible to dispose the color resist layer 40 on one side of the second substrate 20.

As mentioned above, specifically, as shown in FIG. 3, the thin film transistor layer 121 comprises a plurality of thin film transistors. The thin film transistors may be an etch barrier type, a back channel etch type, or a top gate thin film transistor type, it is not specifically limited. For example, the thin film transistors of the top gate thin film transistor type may include an active layer 1211 on the base 11, a gate insulating layer 1212 on the active layer 1211, a gate electrode layer 1213 on the gate insulating layer 1212, a second insulating layer 1214 on the gate electrode layer 1213, and a source-drain electrode layer 1215 on the second insulating layer 1214. The first insulating layer 122 is disposed on the second insulating layer 1214 and the source-drain electrode layer 1215 and covers the source-drain electrode layer 1215.

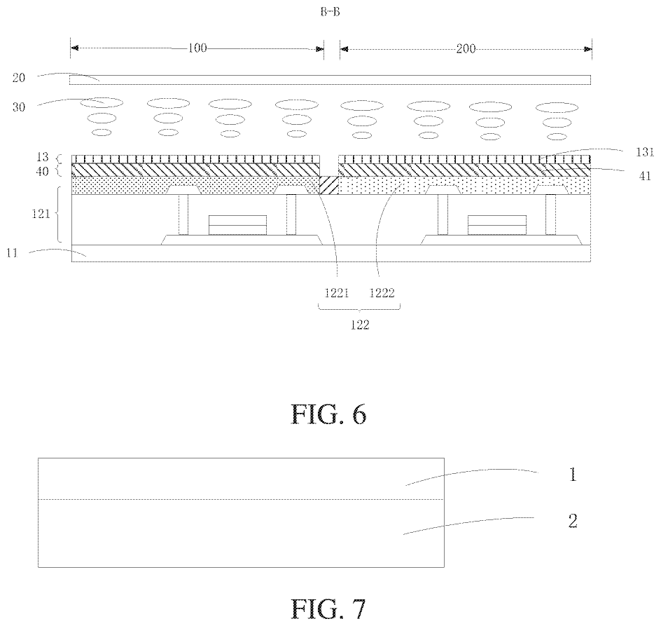

In one embodiment, as shown in FIG. 5 and FIG. 6, the color resist layer 40 is disposed on one side of the first substrate 10, and located between the array structure layer 12 and the pixel electrode 131. The display panel 1 at least comprises a first color sub-pixel area 100 configured to display a first color and a second color sub-pixel area 200 configured to display a second color. The first color sub-pixel area 100 and the second color sub-pixel area 200 are correspondingly provided with one of the pixel electrodes 131, respectively; the first color has a wavelength greater than a wavelength of the second color. It is characterized that the color resist layer 40 comprises a plurality of color resist blocks 41 arranged in an array. Any of the color resist blocks 41 is provided with one pixel electrode 131.

A refractive index of the first insulating layer 122 corresponding to the first color sub-pixel area 100 is greater than a refractive index of the first insulating layer 122 corresponding to the second color sub-pixel area 200; and/or

an average liquid crystal thickness of the liquid crystal layer 30 corresponding to the first color sub-pixel area 100 is greater than an average liquid crystal thickness of the liquid crystal layer 30 corresponding to the second color sub-pixel area 200.

It can be understood that the first substrate 10 is a COA (color filter on array, color resist layer on array) type substrate. When the display panel 1 is in specific use, the backlight sequentially passes through the base 11, the thin film transistor layer 121, the color resist layer 40, the pixel electrode layer 13, the liquid crystal layer 30 and the second substrate 20. The display brightness of the display panel 1 is affected by various factors. Apparently, the display panel 1 at least comprises the first color sub-pixel area 100 configured to display the first color and the second color sub-pixel area 200 configured to display the second color. Because the first color sub-pixel area 100 and the second color sub-pixel area 200 display different colors, and the different wavelengths of light of different colors, the display panel 1 has different brightness in the sub-pixel areas of different colors. Especially at a large viewing angle, the display panel 1 has a color shift. Specifically, the brightness influence factor δ that affects the display of the display panel 1 is as follows:

$$δ = \frac{2 π Δ n d}{λ}$$

In the equation, λ is wavelength, d is the thickness of the liquid crystal layer 30, and Δn is relative refractive index. The wavelength of the first color is greater than the wavelength of the second color. By adjusting the refractive index of the first insulating layer 122 corresponding to the first color sub-pixel area 100 to be greater than the refractive index of the first insulating layer 122 corresponding to the second color sub-pixel area 200; and/or by adjusting the average liquid crystal thickness of the liquid crystal layer 30 corresponding to the first color sub-pixel area 100 to be greater than the average liquid crystal thickness of the liquid crystal layer 30 corresponding to the second color sub-pixel area 200, the brightness influence factor of the first color is equal to the brightness influence factor of the second color to achieve equal display brightness within the first color sub-pixel area 100 and the second color sub-pixel area 200, and to solve the problem of the color shift generated by the display panel 1.

In one embodiment, as shown in FIG. 6, the first insulating layer 122 comprises a first layer 1221 corresponding to the first color sub-pixel area 100 and a second layer 1222 corresponding to the second color sub-pixel area 200. A refractive index of a material of the first layer 1221 is greater than a refractive index of a material of the second layer 1222. Specifically, the first layer 1221 and the second layer 1222 may be made of different materials. The refractive index of the material of the first layer 1221 is greater than the refractive index of the material of the second layer 1222. Alternatively, the first layer 1221 and/or the second layer 1222 may be doped with corresponding materials to affect the refractive index of the first layer 1221 and/or the refractive index of the second layer1222, so that the refractive index of the first layer 1221 is greater than the refractive index of the second layer 1222.

In one embodiment, as shown in FIG. 5, a thickness of the array structure layer 12 corresponding to the first color sub-pixel area 100 is less than a thickness of the array structure layer 12 corresponding to the second color sub-pixel area 200, so that the average liquid crystal thickness of the liquid crystal layer 30 corresponding to the first color sub-pixel area 100 is greater than the average liquid crystal thickness of the liquid crystal layer 30 corresponding to the second color sub-pixel area 200. It can be understood that the first color sub-pixel area 100 and the second color sub-pixel area 200 are correspondingly provided with one of the pixel electrodes 131. The pixel electrodes 131 comprises the first region 1311 and the second region 1312. The first color sub-pixel area 100 and the second color sub-pixel area 200 both comprise one first region 1311 and one second region 1312. The average liquid crystal thickness of the liquid crystal layer 30 corresponding to the first color sub-pixel area 100 is greater than the average liquid crystal thickness of the liquid crystal layer 30 corresponding to the second color sub-pixel area 200. Specifically, the thickness of the liquid crystal layer 30 corresponding to the first region 1311 within the first color sub-pixel area 100 is greater than the thickness of the liquid crystal layer 30 corresponding to the first region 1311 within the second color sub-pixel area 200, and the thickness of the liquid crystal layer 30 corresponding to the second region 1312 within the first color sub-pixel area 100 is greater than the thickness of the liquid crystal layer 30 corresponding to the second region 1312 within the second color sub-pixel area 200, so that the display panel 1 has the same display brightness in the first color sub-pixel area 100 and the second color sub-pixel area 200, and therefore solve the problem of the color shift under large viewing angles in the display panel 1

As mentioned above, specifically as shown in FIG. 5, the thickness of the first insulating layer 122 corresponding to the first color sub-pixel area 100 is less than the thickness of the first insulating layer 122 corresponding to the second color sub-pixel area 200. Apparently, by adjusting the thickness of the first insulating layer 122 corresponding to the first color sub-pixel area 100 and the thickness of the first insulating layer 122 corresponding to the second color sub-pixel area 200, the thickness of the thin film transistor layer 121 is kept constant to achieve the adjustment of the thickness of the array structure layer 12 corresponding to the first color sub-pixel area 100 and the thickness of the array structure layer 12 corresponding to the second color sub-pixel area 200. Apparently, the first insulating layer 122 is located at one side of the array structure layer 12 close to the liquid crystal layer 30, and the thickness of the first insulating layer 122 can be adjusted to minimize the influence on the thin film transistor layer 121 in the array structure layer 12.

It is noted in a specific application that the display panel 1 comprises a red sub-pixel area, a green sub-pixel area, and a blue sub-pixel area. Each of the color resist blocks 41 comprises a first color resist block, a second color resist block, and a third color resist block. The first color resist block, the second color resist block and the third color resist block are any type of combination of the red color resist block, the green color resist block, and the blue color resist block, and the combination is not limited herein. The red color resist block is disposed in the red sub-pixel area, the green color resist block is disposed in the green sub-pixel area, and the blue color resist block is disposed in the blue sub-pixel area. It can be understood that the relationship between the red light wavelength λ_{R}, the green light wavelength λ_{G}, and the blue light wavelength λ_{B} is λ_{R}>λ_{G}>λ_{B}. According to the corresponding thickness d of the liquid crystal layer 30 and the relative refractive index Δn of two different colors corresponding to the first color sub-pixel area 100 and the second color sub-pixel area 200, it can be understood that the thickness of the liquid crystal layer 30 corresponding to the red sub-pixel area, the green sub-pixel area, and the blue sub-pixel area is _{dR}>d_{G}>d_{B}; and/or the relative refractive index is Δn_{R}>Δn_{G}>Δn_{B}. The specific structure is not described herein again.

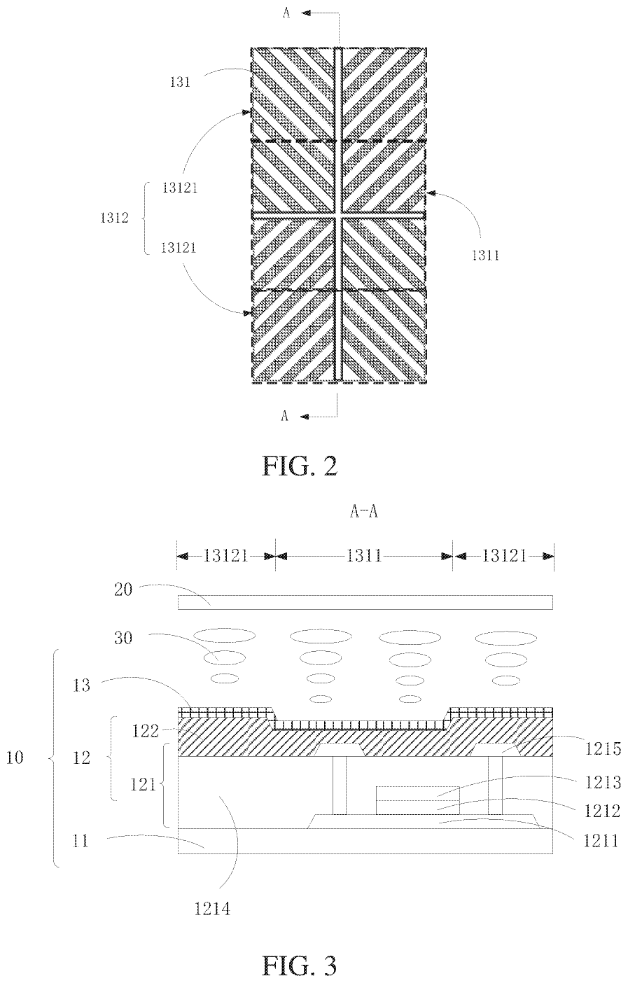

In one embodiment, as shown in FIG. 1 and FIG. 2, the pixel electrode 131 is divided by a dotted line into regions. An area of the first region 1311 is equal to an area of the second region 1312. It can be understood that, in the foregoing, by adjusting the difference between the thickness of the liquid crystal layer 30 corresponding to the first region 1311 and the thickness of the liquid crystal layer 30 corresponding to the second region 1312 in the present disclosure, the sum of the brightness value within the first region 1311 and the brightness value of the second region 1312 is always kept a constant value under different viewing angles, thereby solving the problem of the difference of the viewing angles in the display panel 1 under different viewing angles. By making the area of the first region 1311 equal to the area of the second region 1312, the size relationship between the first region 1311 and the second region 1312 is determined, so that the size relationship between the thickness of the liquid crystal layer 30 corresponding to the first region 1311 and the thickness of the liquid crystal layer 30 corresponding to the second region 1312 can be easily adjusted in order to better realize the complementary brightness of the first region 1311 and the second region 1312 under different viewing angles and improve the effect of the narrow viewing angle in the display panel 1.

In one embodiment, as shown in FIG. 2, the second region 1312 comprises two second sub-regions 13121. The first region 1311 corresponds to the central portion of the pixel electrode 131. The two second sub-regions 13121 correspond to two end portions of the pixel electrode 131, respectively, and are adjacent to two sides of the first region 1311. It can be understood that the first region 1311 and the second region 1312 may be specifically divided into many types. As shown in FIG. 1, the first region and the second region may be symmetrically arranged. In this embodiment, the pixel electrode 131 is a four-domain pixel electrode. The second region 1312 comprises two second sub-regions 13121. The first region 1311 corresponds to the central portion of the pixel electrode 131, and the two second sub-regions 13121 correspond to two end portions of the pixel electrode 131, respectively, and are adjacent to two sides of the first region 1311, and thereby each domain of the pixel electrode 131 is evenly divided into the first region 1311 and the second region1312, for better realizing the complementary brightness of the first region 1311 and the second region 1312 under different viewing angles and improve the effect of the narrow viewing angle in the display panel 1.

The present disclosure further provides a display device, as shown in FIG. 7, the display device comprises a backlight module 2, and abovementioned display panel 1 on the backlight module 2. In this embodiment, the working principal of the display device is same as or similar with the working principal of the display panel 1, and is not described herein.

In summary, the display panel 1 of the present disclosure comprises a first substrate 10, a second substrate 20 opposite to the first substrate 10, and a liquid crystal layer 30 between the first substrate 10 and the second substrate 20. The first substrate 10 comprises a base 11, an array structure layer 12 on the base 11, and a pixel electrode layer 13 on the array structure layer 12. The pixel electrode layer 13 comprises at least one pixel electrode 131, and each of the pixel electrode 131 comprises a first region 1311 and a second region 1312 adjacent to the first region 1311. A thickness of the liquid crystal layer 30 corresponding to the first region 1311 is greater than a thickness of the liquid crystal layer 30 corresponding to the second region 1312. The pixel electrode 131 is divided into a first region 1311 and a second region 1312 adjacent to the first region 1311, and a thickness of the liquid crystal layer 30 corresponding to the first region 1311 is greater than a thickness of the liquid crystal layer 30 corresponding to the second region 1312, so that the light emitted from the liquid crystal layer 30 with different thicknesses shows different brightness to realize the brightness complement of the pixel electrode 131 corresponding to the first region 1311 and the second region 1312, thereby solving the problem of differences of viewing angles under different viewing angles of the display panel with high resolution.

The above mentioned is only preferred embodiments of the present disclosure, and are not intended to limit the present disclosure. Any modification, equivalent replacement, and improvement made within the spirit and principle of the present disclosure shall be included in the protection scope of the present disclosure.

What is claimed is:

1. A display panel, comprising a first substrate, a second substrate opposite to the first substrate, and a liquid crystal layer between the first substrate and the second substrate;
wherein the first substrate comprises a base, an array structure layer on the base, and a pixel electrode layer on the array structure layer; and
the pixel electrode layer comprises at least one pixel electrode, and each of the pixel electrode comprises a first region and a second region adjacent to the first region, wherein a thickness of the liquid crystal layer corresponding to the first region is greater than a thickness of the liquid crystal layer corresponding to the second region.

2. The display panel according to claim 1, wherein a thickness of the array structure layer corresponding to the first region is less than a thickness of the array structure layer corresponding to the second region so that the thickness of the liquid crystal layer corresponding to the first region is greater than the thickness of the liquid crystal layer corresponding to the second region.

3. The display panel according to claim 2, wherein the array structure layer comprises a thin film transistor layer disposed on the base and a first insulating layer disposed on the thin film transistor layer, wherein a thickness of the first insulating layer corresponding to the first region is less than the thickness of the first insulating layer corresponding to the second region.

4. The display panel according to claim 3, wherein the display panel further comprises a color resist layer disposed between the array structure layer and the pixel electrode; the display panel at least comprises a first color sub-pixel area configured to display a first color and a second color sub-pixel area configured to display a second color; the first color sub-pixel area and the second color sub-pixel area are correspondingly provided with one of the pixel electrodes, respectively; the first color has a wavelength greater than a wavelength of the second color;
a refractive index of the first insulating layer corresponding to the first color sub-pixel area is greater than a refractive index of the first insulating layer corresponding to the second color sub-pixel area; and/or
an average liquid crystal thickness of the liquid crystal layer corresponding to the first color sub-pixel area is greater than an average liquid crystal thickness of the liquid crystal layer corresponding to the second color sub-pixel area.

5. The display panel according to claim 4, wherein the first insulating layer comprises a first layer corresponding to the first color sub-pixel area and a second layer corresponding to the second color sub-pixel area, and a refractive index of a material of the first layer is greater than a refractive index of a material of the second layer.

6. The display panel according to claim 4, wherein a thickness of the array structure layer corresponding to the first color sub-pixel area is less than a thickness of the array structure layer corresponding to the second color sub-pixel area, so that the average liquid crystal thickness of the liquid crystal layer corresponding to the first color sub-pixel area is greater than the average liquid crystal thickness of the liquid crystal layer corresponding to the second color sub-pixel area.

7. The display panel according to claim 6, wherein a thickness of the first insulating layer corresponding to the first color sub-pixel area is less than a thickness of the first insulating layer corresponding to the second color sub-pixel area.

8. The display panel according to claim 1, wherein the second region comprises two second sub-regions, the first region corresponds to the central portion of the pixel electrode, the two second sub-regions correspond to two end portions of the pixel electrode, respectively, and are adjacent to two sides of the first region.

9. The display panel according to claim 1, wherein an area of the first region is equal to an area of the second region.

10. A display device, comprising a backlight module, and a display panel on the backlight module;
wherein the display panel comprises a first substrate, a second substrate opposite to the first substrate, and a liquid crystal layer between the first substrate and the second substrate;
wherein the first substrate comprises a base, an array structure layer on the base, and a pixel electrode layer on the array structure layer; and
the pixel electrode layer comprises at least one pixel electrode, and each of the pixel electrode comprises a first region and a second region adjacent to the first region, wherein a thickness of the liquid crystal layer corresponding to the first region is greater than a thickness of the liquid crystal layer corresponding to the second region.

11. The display device according to claim 10, wherein a thickness of the array structure layer corresponding to the first region is less than a thickness of the array structure layer corresponding to the second region so that the thickness of the liquid crystal layer corresponding to the first region is greater than the thickness of the liquid crystal layer corresponding to the second region.

12. The display device according to claim 11, wherein the array structure layer comprises a thin film transistor layer disposed on the base and a first insulating layer disposed on the thin film transistor layer, wherein a thickness of the first insulating layer corresponding to the first region is less than the thickness of the first insulating layer corresponding to the second region.

13. The display device according to claim 12, wherein the display device further comprises a color resist layer disposed between the array structure layer and the pixel electrode; the display panel at least comprises a first color sub-pixel area configured to display a first color and a second color sub-pixel area configured to display a second color; the first color sub-pixel area and the second color sub-pixel area are correspondingly provided with one of the pixel electrodes, respectively; the first color has a wavelength greater than a wavelength of the second color;
a refractive index of the first insulating layer corresponding to the first color sub-pixel area is greater than a refractive index of the first insulating layer corresponding to the second color sub-pixel area; and/or
an average liquid crystal thickness of the liquid crystal layer corresponding to the first color sub-pixel area is greater than an average liquid crystal thickness of the liquid crystal layer corresponding to the second color sub-pixel area.

14. The display device according to claim 13, wherein the first insulating layer comprises a first layer corresponding to the first color sub-pixel area and a second layer corresponding to the second color sub-pixel area, a refractive index of a material of the first layer is greater than a refractive index of a material of the second layer.

15. The display device according to claim 13, wherein a thickness of the array structure layer corresponding to the first color sub-pixel area is less than a thickness of the array structure layer corresponding to the second color sub-pixel area, so that the average liquid crystal thickness of the liquid crystal layer corresponding to the first color sub-pixel area is greater than the average liquid crystal thickness of the liquid crystal layer corresponding to the second color sub-pixel area.

16. The display device according to claim 15, wherein a thickness of the first insulating layer corresponding to the first color sub-pixel area is less than a thickness of the first insulating layer corresponding to the second color sub-pixel area.

17. The display device according to claim 10, wherein the second region comprises two second sub-regions, the first region corresponds to the central portion of the pixel electrode; the two second sub-regions correspond to two end portions of the pixel electrode, respectively, and are adjacent to two sides of the first region.

18. The display device according to claim 10, wherein an area of the first region is equal to an area of the second region.
